(19) United States
(12) Patent Application Publication
(10) Pub. No.: US 2023/0002260 A1
(43) Pub. Date: Jan. 5, 2023

(54) ENRICHING DRINKING WATER WITH ZINC

(71) Applicant: Zinc Water LLC, North Las Vegas, NV (US)

(72) Inventor: Victor Sutton, North Las Vegas, NV (US)

(21) Appl. No.: 17/855,117

(22) Filed: Jun. 30, 2022

Related U.S. Application Data
(60) Provisional application No. 63/217,604, filed on Jul. 1, 2021.

(51) Int. Cl. C02F 1/68; C02F 1/44

(52) U.S. Cl. CPC C02F 1/68; C02F 1/441

(57) ABSTRACT

Methods for producing a zinc-enriched drinking water can include: providing water meeting drinking water standards; measuring a pH of the water; if the pH of the water is below a predetermined threshold, increasing the pH of the water above the predetermined threshold; and adding zinc to the water. The methods can produce a zinc-enriched water product with containing zinc; and having a pH above 7.

### CLAIM OF PRIORITY

This application claims priority to U.S. Provisional Patent Application Ser. No. 63/217,604, filed on Jul. 1, 2021, the entire contents of which are hereby incorporated by reference.

### TECHNICAL FIELD

This disclosure relates to enriching drinking water with zinc and zinc-enriched drinking water.

### BACKGROUND

Minerals are often added to water to be bottled for human consumption. Zinc is an element that is nutritious for humans and is listed on the FDA Daily Nutritional Requirements.

### SUMMARY

This specification describes methods and systems for enriching drinking water with zinc and provides zinc-enriched drinking water. These methods and systems enable enriching alkaline drinking water with zinc while avoiding issues with sedimentation and insolubility.

In one aspect, methods for producing a zinc-enriched drinking water include: providing water meeting drinking water standards; measuring a pH of the water; if the pH of the water is below a predetermined threshold, increasing the pH of the water above the predetermined threshold; and adding zinc to the water. Embodiments of these methods can include one or more of the following features.

Some methods also include adding electrolytes to the water. In some cases, the electrolytes include at least one of: potassium carbonate, potassium bicarbonate, magnesium sulfate, calcium chloride, magnesium chloride, sodium bicarbonate, and dipotassium phosphate.

In some embodiments, providing water comprises purifying water. In some cases, purifying water comprises reverse osmosis. In some cases, purifying water comprises distillation.

In some embodiments, measuring the pH of the water comprises measuring the pH of the water more than one time. In some cases, measuring the pH of the water occurs before increasing the pH of the water and after increasing the pH of the water.

In some embodiments, adding zinc to the water occurs after increasing the pH of the water.

In some embodiments, adding zinc to the water comprises adding zinc sulfate heptahydrate to the water.

In some embodiments, the predetermined threshold is 7.5.

In some embodiments, the predetermined threshold is 9.

In some embodiments, the predetermined threshold is 9.5.

In some embodiments, the adding zinc to the water comprises adding zinc to the water until the zinc is at a concentration in the range of 0.0001 mg/L to 100 mg/L.

In one aspect, zinc-enriched water products include: water; and zinc; wherein the zinc-enriched water product has a pH above 7. Embodiments of these products can include one or more of the following features.

In some embodiments, the water products also include electrolytes. In some cases, the electrolytes include at least one of: potassium carbonate, potassium bicarbonate, magnesium sulfate, calcium chloride, magnesium chloride, sodium bicarbonate, and dipotassium phosphate.

In some embodiments, the zinc is in a concentration in the range of 0.0001 mg/L to 100 mg/L.

Zinc is common in everyday foods, but some people still have zinc deficiencies. One solution to provide an easy way to consume zinc is to infuse zinc into drinking water. However, zinc has yet to be added to alkaline water (e.g., water with a pH above 7) because of its insolubility and likelihood for sedimentation. It can be difficult to infuse zinc into alkaline water while avoiding these issues. These concerns have encouraged manufacturers to restrict the pH of zinc-fortified water.

The described methods and systems are advantageous because they enable enriching alkaline drinking water with zinc while avoiding issues with sedimentation and insolubility. In particular, the described methods and systems can provide alkaline water with a desirable taste and a high concentration of zinc.

### DESCRIPTION OF DRAWINGS

FIG. 1 is an illustration of the production process of zinc-enriched water.

### DETAILED DESCRIPTION

This specification describes methods and systems for enriching drinking water with zinc and provides zinc-enriched drinking water. These methods and systems enable enriching alkaline drinking water with zinc while avoiding issues with sedimentation and insolubility. Drinking zinc-enriched water can help consumers fulfill nutritional needs (e.g., meet levels listed on the FDA Daily Nutritional Requirements).

The present methods and systems enable enriching alkaline drinking water. Generally, drinking water is neutral on the pH scale. However, some consumers prefer drinks with a higher pH (e.g., above 7). For example, alkaline water typically has a pH of 8 or 9 and contains alkaline minerals and negative oxidation reduction potential (ORP). Several small scientific studies have been and are being performed to investigate claims that alkaline water may help deactivate pepsin (i.e., an enzyme that contributes to acid reflux), may have benefits for people with high blood pressure, diabetes, and high cholesterol, and may reduce whole blood viscosity when consumed after a strenuous workout.

It is difficult to enrich alkaline drinking water with zinc because solubility of zinc decreases with increasing pH and zinc can precipitate out of solution forming solid particles. The solid particles can cause the water to appear cloudy and/or the solid particles can settle forming visible sediments on the bottom of a container. Sedimentations can discourage consumers from drinking the zinc-enriched water. However, different forms of zinc have different solubility in water, and some forms are more soluble in water with a higher pH. For example, zinc sulfate heptahydrate can be highly absorbable and water soluble in alkaline drinking water.

The present methods and systems utilize hydrated zinc sulfate, which is less likely sediment within water with a pH greater than 7.5. Zinc sulfate heptahydrate is likely to precipitate in alkaline water and while also remaining absorbable upon its consumption. Therefore, zinc sulfate heptahydrate can be a desirable form of zinc for providing zinc-enriched alkaline water.

Manufacturers are typically avoid using hydrated zinc sulfate to add zinc to alkaline water because anhydrates are normally highly soluble in water, making anhydrates the more suitable choice in terms of solubility. Therefore, it is more practical to use an anhydrous salt instead of a hydrated one in providing zinc-enriched drinking water. However, a drawback to using an anhydrate to enrich water is that the enriched water can appear cloudy (e.g., water appears cloudy when table salt is added). Zinc sulfate, which is white in its anhydrous form, could cause the water to appear whiter or cloudier than natural water. Therefore, although hydrated zinc sulfate is less soluble, the present methods and systems use hydrated zinc sulfate (e.g., zinc sulfate heptahydrate) to enrich water with zinc.

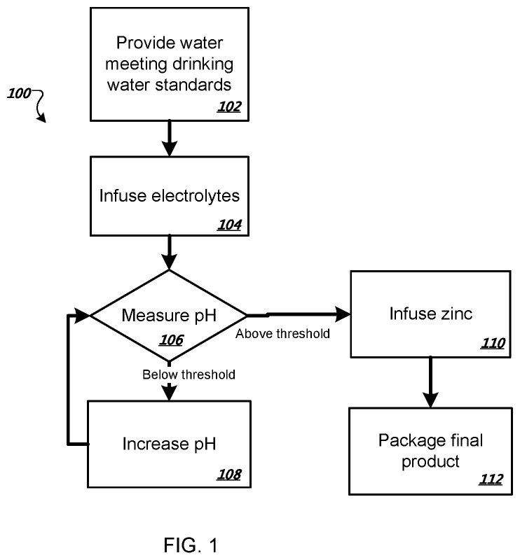

FIG. 1 illustrates an exemplary method 100 of enriching drinking water with zinc. Optionally, the water is purified (step 102) so that it is safe for human consumption. In some implementations, drinking water can be purified through reverse osmosis. In reverse osmosis, water is filtered through a semipermeable membrane that prevents large particles (e.g., bacteria, unwanted molecules, etc.) from passing through. In other implementations, the water is purified in other ways (e.g., distillation). In certain implementations, water is provided that is already safe for human consumption and does not need to be purified. For example, drinking water that meets, e.g., HACCP guidelines, the Nevada Health Department NAC 445A, the U.S. FDA 21 CFR according to current Good Manufacturing Practices (cGMP) part 110 and 111, Beverage/Bottle Water Standards part 165 can be provided.

After being purified, the water is infused with electrolytes (step 104). The electrolytes can be added to the water through a liquid solution containing the electrolytes (e.g., a 50% concentration of electrolytes by weight, a 60% concentration, etc.). The electrolytes can be, e.g., electrically charged minerals, molecules, etc. which can add tastes or desirable nutrients (e.g., potassium or calcium) to the water. Electrolytes that are added to the water may include, but are not limited to, e.g., potassium carbonate, potassium bicarbonate, magnesium sulfate, calcium chloride, magnesium chloride, sodium bicarbonate, and dipotassium phosphate. These electrolytes can also add different tastes when infused into the water. For example, some consumers may think that zinc has an undesirable taste. Electrolytes can be infused within the water and can change the taste of the water so that consumers do not taste zinc in the water. For example, the water can have a range of electrolyte concentrations (e.g., 90% purified water and a 10% aqueous concentration of electrolytes, 95% purified water and 5% aqueous concentration of electrolytes, 85% purified water and 15% aqueous concentration of electrolytes) after infusion. The concentration of electrolytes can significantly change the taste of the water. The electrolytes can also change the pH of the water. For example, some of the electrolytes listed above (e.g., sodium bicarbonate) will raise the pH of water when infused into the water.

After the electrolytes are infused into the water, the pH of the water is measured (step 106) to check if it is above a predetermined threshold. The pH of the water can be measured e.g., with a portable electronic pH meter, an inline pH meter, or a pH strip. For alkaline water, the predetermined threshold will be a pH greater than neutral (e.g., 7.25, 7.5, 8, 8.5, 9, 9.5, 10, or 10.5). If the measured pH is below the predetermined threshold, the pH of the water will be increased. If the measured pH meets or exceeds the predetermined threshold, the water will be enriched with zinc. In some implementations, the zinc may be added before measuring the pH of the water.

If the measured pH is below the predetermined threshold, the pH of the water is increased (step 108). One technique to increase the pH of the water is to add certain solutes (e.g., ions, compounds) to the water to increase the pH value. Solutes that can be added to the water to increase the pH may include, but are not limited to, e.g., tripotassium phosphate, potassium bicarbonate, potassium hydroxide, sodium hydroxide, magnesium chloride and calcium chloride. The solutes can be added to the water through a liquid containing the solutes (e.g., a 50% concentration by weight or a 60% concentration by weight). The solutes can be added at once in a predetermined amount, or the solutes may be added slowly. After solutes are added to increase the pH of the water, the pH of the water is measured again. The process can loop between measuring the pH of the water and increasing the pH of the water until the measured pH of the water meets or exceeds the predetermined threshold. The water will be enriched with zinc. In other implementations, the pH of the water may be continuously monitored while adding solutes to the water until the pH reaches or exceeds the predetermined threshold.

Some guidelines suggest maximum concentrations of zinc, e.g., according to the Secondary Drinking Water Standards: Guidance for Nuisance Chemicals, zinc is listed at a maximum of 5 mg/L because of its metallic taste. The disclosed methods and systems provide a number of steps to overcome a metallic taste. For example, the disclosed methods may use zinc sulfate heptahydrate, which does a better job of disguising the metallic taste than other zinc compounds and zinc sulfate forms. In another example, the disclosed methods can include adding electrolytes to improve the taste and disguise the metallic taste of zinc.

After the measured pH of the water meets or exceeds the predetermined threshold, zinc is infused into the water (step 110) to provide desirable nutrients and health benefits. Zinc can be added to the water using a pipette or machine that adds a specified amount of zinc compound to each bottle during production. The zinc can be infused with the water to provide drinking water with a range of concentrations. For example, the water produced can have between 0.5 milligrams (mg) of zinc per liter (L) and about 25 mg/L. Zinc can be also introduced into the water through several molecules. For example, zinc sulfate can be mixed with the water to infuse the zinc, e.g., zinc sulfate heptahydrate can be highly water soluble and highly absorbable by the human body after consumption. Other molecules containing zinc may not be soluble in water with a pH above about 7.5. However, zinc sulfate heptahydrate can be soluble in water with a pH above about 7.5. Other soluble zinc compounds (e.g., zinc acetate) may be used instead of, or in concert with, zinc sulfate. After the zinc is infused to the desired level, the water is packaged into a container (e.g., a water bottle, a jug, or a barrel). The container can be made composed of, e.g., plastic, metal, ceramic, or a combination of these materials. Once packaged, the zinc-enriched water is ready to be shipped, sold, or otherwise transferred to a consumer.

An exemplary final product of the present methods and systems is a water with a pH above a predetermined threshold pH (e.g., 9, 9.5, or 10) containing zinc and electrolytes and packaged into a container. The zinc in in the water can have a range of concentrations (e.g., about 0.5 mg/L to about 25 mg/L). The zinc can be in various forms of compounds (e.g., zinc sulfate, zinc sulfate heptahydrate, zinc acetate). Electrolytes that are in the water may include, but are not limited to, e.g., potassium carbonate, potassium bicarbonate, magnesium sulfate, calcium chloride, magnesium chloride, sodium bicarbonate, and dipotassium phosphate. Different electrolytes and amounts may be in the water for desirable tastes or nutrients.

This specification describes methods and systems for enriching drinking water with zinc and zinc-enriched drinking water. It will be appreciated that various changes may be made by those skilled in the art without departing from the spirit and scope of the invention, which is limited only by the following claims.

What is claimed is:

1. A method for producing a zinc-enriched drinking water, the method comprising:
providing water meeting drinking water standards;
measuring a pH of the water;
if the pH of the water is below a predetermined threshold, increasing the pH of the water above the predetermined threshold; and
adding zinc to the water.

2. The method of claim 1, further comprising adding electrolytes to the water.

3. The method of claim 2, wherein the electrolytes include at least one of: potassium carbonate, potassium bicarbonate, magnesium sulfate, calcium chloride, magnesium chloride, sodium bicarbonate, and dipotassium phosphate.

4. The method of claim 1, wherein providing water comprises purifying water.

5. The method of claim 4, wherein purifying water comprises reverse osmosis.

6. The method of claim 4, wherein purifying water comprises distillation.

7. The method of claim 1, wherein measuring the pH of the water comprises measuring the pH of the water more than one time.

8. The method of claim 7, wherein measuring the pH of the water occurs before increasing the pH of the water and after increasing the pH of the water.

9. The method of claim 1, wherein adding zinc to the water occurs after increasing the pH of the water.

10. The method of claim 1, wherein adding zinc to the water comprises adding zinc sulfate heptahydrate to the water.

11. The method of claim 1, wherein the predetermined threshold is 7.5.

12. The method of claim 1, wherein the predetermined threshold is 9.

13. The method of claim 1, wherein the predetermined threshold is 9.5.

14. The method of claim 1, wherein the adding zinc to the water until the zinc is at a concentration in the range of 0.0001 mg/L to 100 mg/L.

15. A zinc-enriched water product comprising:
water; and
zinc;
wherein the zinc-enriched water product has a pH above 7.

16. The packaged zinc-enriched water product of claim 15, further comprising electrolytes.

17. The packaged zinc-enriched water product of claim 16, wherein the electrolytes include at least one of: potassium carbonate, potassium bicarbonate, magnesium sulfate, calcium chloride, magnesium chloride, sodium bicarbonate, and dipotassium phosphate.

18. The packaged zinc-enriched water product of claim 15, wherein the zinc is in a concentration in the range of 0.0001 mg/L to 100 mg/L.
